(19) United States
(12) Patent Application Publication
(10) Pub. No.: US 2026/0366107 A1
(43) Pub. Date: Nov. 19, 2026

(54) NON-ORIENTED ELECTRICAL STEEL SHEET AND METHOD FOR MANUFACTURING SAME

(71) Applicant: Hyundai Steel Company, Incheon (KR)

(72) Inventors: Sung Tae Lee, Incheon (KR); Kang Roh Lee, Incheon (KR); Chun Ku Kang, Incheon (KR)

(73) Assignee: Hyundai Steel Company, Incheon (KR)

(21) Appl. No.: 19/720,254

(22) Filed: Jun. 25, 2026

Related U.S. Application Data
(63) Continuation of application No. PCT/KR2024/021248, filed on Dec. 27, 2024.

(30) Foreign Application Priority Data
Dec. 28, 2023 (KR) 1020230195407

(51) Int. Cl. C22C 38/00; C21D 6/00; C21D 8/1216; C21D 8/1244; C21D 9/46; C22C 38/02; C22C 38/04; C22C 38/06; C22C 38/14; H01F 1/147

(52) U.S. Cl. CPC C22C 38/002; C21D 6/005; C21D 6/008; C21D 8/1222; C21D 8/1233; C21D 8/1261; C21D 9/46; C22C 38/001; C22C 38/004; C22C 38/005; C22C 38/02; C22C 38/04; C22C 38/06; C22C 38/14; H01F 1/14775; C22C 2202/02

(57) ABSTRACT

In one aspect, a method of manufacturing a non-oriented electrical steel sheet includes a hot rolling operation of producing a hot-rolled steel sheet by hot-rolling a slab including, in wt %, silicon (Si) of 1.0 wt % to 1.5 wt %, manganese (Mn) of 0.1 wt % to 0.4 wt %, aluminum (Al) of 0.1 wt % to 0.4 wt %, sulfur (S) of more than 0 wt % to 0.003 wt %, a sum of one or more elements of more than 0.0006 wt % to 0.0030 wt %, the one or more elements being selected from the group consisting of neodymium (Nd), praseodymium (Pr), and yttrium (Y), remainder iron (Fe), and unavoidable impurities, a cold rolling operation of producing a cold-rolled steel sheet by cold-rolling the hot-rolled steel sheet, and a cold annealing operation of cold-annealing the cold-rolled steel sheet.

### CROSS-REFERENCE TO THE RELATED APPLICATIONS

This application is a continuation of International Application No. PCT/KR2024/021248 filed Dec. 27, 2024, which claims the benefit of Korean Patent Application No. 10-2023-0195407, filed Dec. 28, 2023, in the Korean Intellectual Property Office, the entire contents of which applications are incorporated herein by reference.

### FIELD

The present disclosure relates to a non-oriented electrical steel sheet and a method of manufacturing the same.

### BACKGROUND

Recently, with the worldwide strengthening of environmental regulations, the automotive industry has shifted from conventional internal combustion engines to eco-friendly cars (e.g., hybrid cars and electric cars). Unlike conventional internal combustion engines powered by fossil fuel, eco-friendly cars generate power from motors powered by batteries.

For improvement of motor efficiency, electric car driving motors have required improved magnetic properties of non-oriented electrical steel sheets used as motor core materials, and the development of electric car driving motors has been accelerated with increasing demand for electric cars.

In general, electrical steel sheets are classified into grain-oriented electrical steel sheets and non-oriented electrical steel sheets, and the grain-oriented electrical steels are mainly used in fixed components such as transformers. On the other hand, the non-oriented electrical steel sheets are mainly used in rotating car driving motors because they have a uniform magnetic property in all directions regardless of rolling directions.

A non-oriented electrical steel sheet has to uniformly generate a <100> orientation texture, which facilitates magnetization, throughout the sheet and has to reduce a core loss and increase a magnetic flux density for energy efficiency. In this case, the core loss refers to an energy loss generated in a magnetization process, and the magnetic flux density refers to a force for generating power.

There are various approaches to researches for improving the magnetic characteristics of conventional non-oriented electrical steel sheets, but in terms of component control, there is a tendency to just add elements such as tin (Sn) and antimony (Sb) with respect to silicon (Si), aluminum (Al), and manganese (Mn) that are basic components.

However, research on various elements is currently required to develop electrical steel sheets with even higher magnetic characteristics.

### SUMMARY

Embodiments of the present disclosure may provide a non-oriented electrical steel sheet with improved magnetic characteristics by controlling the alloy components of a non-oriented electrical steel sheet, and a method of manufacturing the same.

According to an embodiment of the present disclosure, a method of manufacturing a non-oriented electrical steel sheet comprises:
i) a hot rolling operation comprising producing a hot-rolled steel sheet by hot-rolling a slab including, in wt % (based on total weight of the slab), silicon (Si) of 1.0 wt % to 1.5 wt %, manganese (Mn) of 0.1 wt % to 0.4 wt %, aluminum (Al) of 0.1 wt % to 0.4 wt %, sulfur (S) of more than 0 wt % to 0.003 wt %, a sum of one or more elements of more than 0.0006 wt % to 0.0030 wt %, the one or more elements being selected from the group consisting of neodymium (Nd), praseodymium (Pr), and yttrium (Y), remainder iron (Fe), and unavoidable impurities;
ii) a cold rolling operation comprising producing a cold-rolled steel sheet by cold-rolling the hot-rolled steel sheet, and
iii) a cold annealing operation comprising cold-annealing the cold-rolled steel sheet. A non-oriented electrical steel sheet is suitably provided by the method such as following the cold-annealing.

In a further embodiment, a method of manufacturing a non-oriented electrical steel sheet, the method comprising:
i) hot-rolling a slab comprising, in wt % (based on total weight of the slab), silicon (Si) of 1.0 wt % to 1.5 wt %, manganese (Mn) of 0.1 wt % to 0.4 wt %, aluminum (Al) of 0.1 wt % to 0.4 wt %, sulfur (S) of more than 0 wt % to 0.003 wt %, a sum of one or more elements of more than 0.0006 wt % to 0.0030 wt %, the one or more elements being selected from the group consisting of neodymium (Nd), praseodymium (Pr), and yttrium (Y), remainder iron (Fe), and unavoidable impurities to provide hot-rolled steel sheet;
ii) cold-rolling the hot-rolled steel sheet to provide a cold-rolled steel sheet; and
iii) cold-annealing the cold-rolled steel sheet. A non-oriented electrical steel sheet is suitably provided by the method such as following the cold-annealing.

In present embodiments of the above methods, a ratio of sulfide-based inclusions with a diameter of 10 nm to 100 nm to all sulfide-based inclusions may satisfy Relationship 1 below.

A/B*100≤15% <Relationship 1>

In Relationship 1, A may be a number of sulfide-based inclusions with a diameter of 10 nm to 100 nm, and B may be a number of all sulfide-based inclusions.

In present embodiments of the above methods, a ratio of sulfide-based inclusions with a diameter of 10 nm to 50 nm to sulfide-based inclusions with a diameter of 10 nm to 100 nm and a ratio of sulfide-based inclusions with a diameter of 50 nm to 100 nm to the sulfide-based inclusions with a diameter of 10 nm to 100 nm may satisfy Relationship 2 below.

(S_{10~50})²/(S_{50~100})≤20 <Relationship 2>

In Relationship 2, S_{10~50} may correspond to the ratio of the sulfide-based inclusions with a diameter of 10 nm to 50 nm to the sulfide-based inclusions with a diameter of 10 nm to 100 nm, and S_{50~100} may correspond to the ratio of the sulfide-based inclusions with a diameter of 50 nm to 100 nm to the sulfide-based inclusions with a diameter of 10 nm to 100 nm.

In present embodiments of the above methods, the non-oriented electrical steel sheet may have a magnetic flux density of 1.695 T or more (based on B₅₀).

In present embodiments of the above methods, an average grain size of the non-oriented electrical steel sheet may be 50 μm to 100 μm.

In present embodiments of the above methods, in the hot rolling operation or hot rolling step, the slab may be reheated to about 1100 °C to about 1250 °C, and the reheated slab may be hot-rolled at a final rolling temperature of 800 °C to 1000 °C.

In present embodiments of the above methods in the cold annealing operation or cold annealing step, the cold-rolled steel sheet may be heated to a temperature of about 900 °C to about 1100 °C at a heating rate of 10 °C/s or more, maintained at a temperature of 900 °C to 1100 °C for a time of 30 s to 90 s, and then cooled at a cooling rate of 30 °C/s or more.

In the present embodiments of the above methods, the slab may include a sum of one or more elements of 0.0007 wt % to 0.0030 wt %, the one or more elements being selected from the group consisting of neodymium (Nd), praseodymium (Pr), and yttrium (Y).

In the present embodiments of the above methods, the slab may further include carbon (C) of more than 0 wt % to 0.003 wt %, phosphorus (P) of more than 0 wt % to 0.1 wt %, nitrogen (N) of more than 0 wt % to 0.003 wt %, and titanium (Ti) of more than 0 wt % to 0.003 wt %.

Another embodiment of the present disclosure, a non-oriented electrical steel sheet includes, in wt % (based on total weight of the sheet), silicon (Si) of 1.0 wt % to 1.5 wt %, manganese (Mn) of 0.1 wt % to 0.4 wt %, aluminum (Al) of 0.1 wt % to 0.4 wt %, sulfur (S) of more than 0 wt % to 0.003 wt %, a sum of one or more elements of more than 0.0006 wt % to 0.0030 wt %, the one or more elements being selected from the group consisting of neodymium (Nd), praseodymium (Pr), and yttrium (Y), remainder iron (Fe), and unavoidable impurities.

In present embodiment, a ratio of sulfide-based inclusions with a diameter of 10 nm to 100 nm to all sulfide-based inclusions may satisfy Relationship 3 below.

A/B*100≤15% <Relationship 3>

In Relationship 3, A may be a number of sulfide-based inclusions with a diameter of 10 nm to 100 nm, and B may be a number of all sulfide-based inclusions.

In present embodiment, a ratio of sulfide-based inclusions with a diameter of 10 nm to 50 nm to sulfide-based inclusions with a diameter of 10 nm to 100 nm and a ratio of sulfide-based inclusions with a diameter of 50 nm to 100 nm to the sulfide-based inclusions with a diameter of 10 nm to 100 nm may satisfy Relationship 4 below.

(S_{10~50})²/(S_{50~100})≤20 <Relationship 2>

In Relationship 4, S_{10~50} may correspond to the ratio of the sulfide-based inclusions with a diameter of 10 nm to 50 nm to the sulfide-based inclusions with a diameter of 10 nm to 100 nm, and S_{50~100} may correspond to the ratio of the sulfide-based inclusions with a diameter of 50 nm to 100 nm to the sulfide-based inclusions with a diameter of 10 nm to 100 nm.

In present embodiment, the non-oriented electrical steel sheet may have a magnetic flux density of 1.695 T or more (based on B₅₀).

In present embodiment, an average grain size of the non-oriented electrical steel sheet may be 50 μm to 100 μm.

In the present embodiment, the slab may include a sum of one or more elements of 0.0007 wt % to 0.0030 wt %, the one or more elements being selected from the group consisting of neodymium (Nd), praseodymium (Pr), and yttrium (Y).

In the present embodiment, the non-oriented electrical steel sheet may further include carbon (C) of more than 0 wt % to 0.003 wt %, phosphorus (P) of more than 0 wt % to 0.1 wt %, nitrogen (N) of more than 0 wt % to 0.003 wt %, and titanium (Ti) of more than 0 wt % to 0.003 wt %.

As referred to herein, magnetic characteristics (magnetic flux density B₅₀) can be obtained by performing electrical steel strip test methods according to JIS C 2550-1 (2011) and 2550-3 (2011) on Epstein test pieces. The magnetic flux density B₅₀ obtained by a main test before the additional heat treatment was defined as magnetic flux density BA (T). Epstein test pieces can be cut out in the rolling direction (L direction) and an orthogonal-to-rolling direction (C direction), respectively, from a non-oriented electrical steel sheets according to JIS C 2550-1 (2011).

In a further aspect, vehicles (including electric-powered vehicles) are provided that comprise a non-oriented electrical steel sheet as disclosed herein. In a further aspect, electric car driving motors are provided that comprise a non-oriented electrical steel sheet as disclosed herein.

Other aspects, features, and advantages other than those described above will become apparent from the following detailed description, the appended claims, and the accompanying drawings.

As described above, according to an embodiment of the present disclosure, the magnetic characteristics of the non-oriented electrical steel sheet may be improved by controlling the alloy components of the non-oriented electrical steel sheet. However, the scope of the present disclosure is not limited to these effects.

### BRIEF DESCRIPTION OF DRAWINGS

FIG. 1 is a flowchart schematically illustrating a method of manufacturing a non-oriented electrical steel sheet, according to an embodiment of the present disclosure.

### DETAILED DESCRIPTION

The present disclosure may include various embodiments and modifications, and certain embodiments thereof are illustrated in the drawings and will be described herein in detail. The advantages and features of the present disclosure and the accomplishing methods thereof will become apparent from the embodiments described below in detail with reference to the accompanying drawings. However, the present disclosure is not limited to the embodiments described below, and may be embodied in various modes.

It will be understood that although terms such as “first” and “second” may be used herein to describe various elements, these elements should not be limited by these terms and these terms are only used to distinguish one element from another element.

As used herein, the singular forms “a”, “an”, and “the” are intended to include the plural forms as well, unless the context clearly indicates otherwise.

It will be understood that terms such as “comprise,” “include,” and “have” used herein specify the presence of stated features or components, but do not preclude the presence or addition of one or more other features or components.

Sizes of elements in the drawings may be exaggerated for convenience of description. In other words, because the sizes and shapes of components in the drawings are arbitrarily illustrated for convenience of description, the present disclosure is not limited thereto.

When a certain embodiment may be implemented differently, a particular process order may be performed differently from the described order. For example, two processes described in succession may be performed substantially at the same time or may be performed in an order opposite to the described order.

As used herein, “A and/or B” represents the case of A, B, or A and B. Also, “at least one of A and B” represents the case of A, B, or A and B.

It is understood that the term “vehicle” or “vehicular” or other similar term as used herein is inclusive of motor vehicles in general such as passenger automobiles comprising sports utility vehicles (SUV), buses, trucks, various commercial vehicles, watercraft comprising a variety of boats and ships, aircraft, and the like, and comprises hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”. Hereinafter, embodiments of the present disclosure will be described in detail with reference to the accompanying drawings, and in the following description, like reference numerals will denote like elements and redundant descriptions thereof will be omitted.

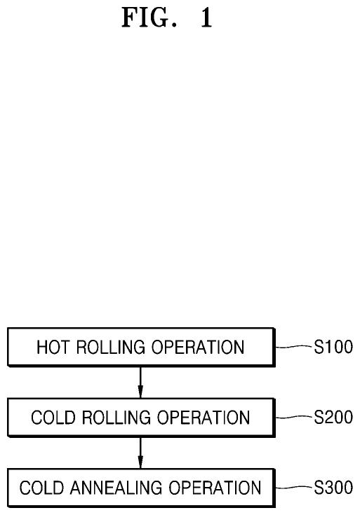

FIG. 1 is a flowchart schematically illustrating a method of manufacturing a non-oriented electrical steel sheet, according to an embodiment of the present disclosure.

Referring to FIG. 1, the method of manufacturing a non-oriented electrical steel sheet may include a hot rolling operation S100, a cold rolling operation S200, and a cold annealing operation S300.

In the method of manufacturing a non-oriented electrical steel sheet, according to an embodiment of the present disclosure, a semi-finished product subjected to hot rolling may be a slab. The slab in a semi-finished state may be obtained through a continuous casting process after obtaining molten steel of a certain composition through a steelmaking process.

First, the slab may be produced through a continuous casting process. The slab may include silicon (Si), manganese (Mn), aluminum (Al), sulfur (S), rare earth elements, remainder iron (Fe), and unavoidable impurities. In this case, the rare earth elements may include one or more elements selected from the group consisting of neodymium (Nd), praseodymium (Pr), and yttrium (Y). Also, the slab may further include carbon (C), phosphorus (P), nitrogen (N), and titanium (Ti).

Particularly, the slab may include, in wt %, silicon (Si) of 1.0 wt % to 1.5 wt %, manganese (Mn) of 0.1 wt % to 0.4 wt %, aluminum (Al) of 0.1 wt % to 0.4 wt %, sulfur (S) of more than 0 wt % to 0.003 wt %, rare earth elements of more than 0.0006 wt % to 0.0030 wt %, remainder iron (Fe), and unavoidable impurities. In this case, the rare earth elements may include one or more elements selected from the group consisting of neodymium (Nd), praseodymium (Pr), and yttrium (Y). Thus, the slab may include a sum of one or more elements of more than 0.0006 wt % to 0.0030 wt %, the one or more elements being selected from the group consisting of neodymium (Nd), praseodymium (Pr), and yttrium (Y). For example, the slab may include a sum of one or more elements of 0.0007 wt % to 0.0030 wt %, the one or more elements being selected from the group consisting of neodymium (Nd), praseodymium (Pr), and yttrium (Y).

Also, the slab may further include carbon (C) of more than 0 wt % to 0.003 wt %, phosphorus (P) of more than 0 wt % to 0.1 wt %, nitrogen (N) of more than 0 wt % to 0.003 wt %, and titanium (Ti) of more than 0 wt % to 0.003 wt %.

Silicon (Si) may be a main additive element as a component that reduces a core loss by increasing the resistivity of a manufactured non-oriented electrical steel sheet. The content of silicon (Si) may be 1.0 wt % to 1.5 wt %. When the content of silicon (Si) is less than 1.0 wt %, it may be difficult to achieve a target core loss value of the manufactured non-oriented electrical steel sheet. That is, when the content of silicon (Si) is less than 1.0 wt %, it may be difficult to achieve a low core loss. On the other hand, a magnetic permeability and a magnetic flux density may decrease as the content of silicon (Si) increases. When the content of silicon (Si) is more than 1.5 wt %, the magnetic flux density may decrease, the difficulty of the manufacturing process may increase, and the manufacturing cost may increase. Also, the present disclosure may be characterized by improving the magnetic characteristics of the manufactured non-oriented electrical steel sheet by reducing the number of sulfide-based inclusions with a diameter of 10 nm to 100 nm by adding a sum of one or more elements of more than 0.0006 wt % to 0.0030 wt % (e.g., 0.0007 wt % to 0.0030 wt %), the one or more elements being selected from the group consisting of neodymium (Nd), praseodymium (Pr), and yttrium (Y) to the slab; however, when the content of silicon (Si) is more than 1.5 wt %, even when a sum of one or more elements of more than 0.0006 wt % to 0.0030 wt % (e.g., 0.0007 wt % to 0.0030 wt %), the one or more elements being selected from the group consisting of neodymium (Nd), praseodymium (Pr), and yttrium (Y) are added, the number of sulfide-based inclusions with a diameter of 10 nm to 100 nm may not be reduced and thus the effect of adding one or more elements selected from the group consisting of neodymium (Nd), praseodymium (Pr), and yttrium (Y) may be negligible. For example, the content of silicon (Si) may be 1.1 wt % to 1.5 wt %. When the content of silicon (Si) is 1.1 wt % to 1.5 wt %, the manufactured non-oriented electrical steel sheet may have a lower core loss. For example, the content of silicon (Si) may be 1.2 wt % to 1.5 wt %.

Manganese (Mn) may be an element that increases the resistivity of the non-oriented electrical steel sheets manufactured with silicon, lowers the core loss, and forms sulfur (S) and sulfide-based inclusions (e.g., MnS). The content of manganese (Mn) may be 0.1 wt % to 0.4 wt %. When the content of manganese (Mn) is less than 0.1 wt %, the effect of lowering the core loss may be insufficient. On the other hand, when the content of manganese (Mn) is more than 0.4 wt %, it may form fine MnS precipitates to increase the core loss.

Aluminum (Al) may increase the resistivity of the non-oriented electrical steel sheets manufactured with silicon, lower the core loss, and form nitrogen (N) and nitride-based inclusions (e.g., AlN). The content of aluminum (Al) may be 0.1 wt % to 0.4 wt %. When the content of the aluminum (Al) is less than 0.1 wt %, fine nitride-based inclusions (e.g., AlN) may precipitate to have a negative effect on magnetism. On the other hand, when the content of aluminum (Al) is more than 0.4 wt %, a problem may occur in the steelmaking/continuous casting process.

Sulfur (S) may a component that forms a precipitate such as MnS or TIS to increase the core loss and suppress the grain growth. Thus, the content of sulfur in the slab may be low. The content of sulfur may be more than 0 wt % to 0.003 wt %. When the content of sulfur is more than 0.003 wt %, a precipitate such as MnS or TIS may be formed to increase the core loss and suppress the grain growth.

Carbon (C) may be a component that forms carbide such as TiC to increase the core loss, and the content of carbon in the slab may be lower. The content of carbon may be more than 0 wt % to 0.003 wt %. When the content of carbon is more than 0.003 wt %, magnetic aging may occur to degrade the magnetic property of the manufactured non-oriented electrical steel sheet. When the content of carbon is 0.003 wt % or less, the magnetic aging may be suppressed.

Phosphorus (P) may be a grain boundary segregation element and may be a component that develops the texture. The content of phosphorus may be more than 0 wt % to 0.1 wt %. When the content of phosphorus is more than 0.1 wt %, the grain growth may be suppressed due to the segregation effect, the magnetic property may be degraded, and the cold rollability may be degraded.

Nitrogen (N) may form a precipitate such as AlN or TiN to increase the core loss and suppress the grain growth. Thus, the content of nitrogen in the slab may be low. The content of nitrogen may be more than 0 wt % to 0.003 wt %. When the content of nitrogen is more than 0.003 wt %, a precipitate such as AlN or TiN may be formed to increase the core loss and suppress the grain growth.

Titanium (Ti) may form a fine precipitate such as TIC, TiN, or TIS to suppress the grain growth. Because the magnetic property degrades as titanium is added more, titanium may be added as low as possible. The content of titanium may be more than 0 wt % to 0.003 wt %. When the content of titanium is more than 0.003 wt %, it may form a fine precipitate such as TIC, TiN, or TIS to suppress the grain growth and degrade the magnetic property.

In an embodiment, the slab may include a sum of one or more elements of more than 0.0006 wt % to 0.0030 wt %, the one or more elements being selected from the group consisting of neodymium (Nd), praseodymium (Pr), and yttrium (Y). For example, the slab may include a sum of one or more elements of 0.0007 wt % to 0.0030 wt %, the one or more elements being selected from the group consisting of neodymium (Nd), praseodymium (Pr), and yttrium (Y). When the sum of one or more elements selected from the group consisting of neodymium (Nd), praseodymium (Pr), and yttrium (Y) satisfies more than 0.0006 wt % to 0.0030 wt % (e.g., 0.0007 wt % to 0.0030 wt %), the amount (or number) of sulfide-based inclusions with a diameter of 10 nm to 100 nm among all sulfide-based inclusions may be reduced and thus the core loss of the manufactured non-oriented electrical steel sheet may decrease and the magnetic flux density may increase. For example, when the sum of one or more elements selected from the group consisting of neodymium (Nd), praseodymium (Pr), and yttrium (Y) satisfies more than 0.0006 wt % to 0.0030 wt % (e.g., 0.0007 wt % to 0.0030 wt %), the ratio of sulfide-based inclusions with a diameter of 10 nm to 100 nm to all sulfide-based inclusions may be 15% or less and thus the core loss of the manufactured non-oriented electrical steel sheet may decrease and the magnetic flux density may increase.

When the sum of one or more elements selected from the group consisting of neodymium (Nd), praseodymium (Pr), and yttrium (Y) is 0.0006 wt % or less, the content of rare earth elements may be too low to achieve the above effect. On the other hand, when the sum of one or more elements selected from the group consisting of neodymium (Nd), praseodymium (Pr), and yttrium (Y) is more than 0.0030 wt %, the above effect may not be achieved. Particularly, when the sum of one or more elements selected from the group consisting of neodymium (Nd), praseodymium (Pr), and yttrium (Y) is more than 0.0030 wt %, the amount (or number) of sulfide-based inclusions with a diameter of 10 nm to 100 nm to all sulfide-based inclusions may increase and thus the core loss of the manufactured non-oriented electrical steel sheet may increase and the magnetic flux density may decrease. For example, when the sum of one or more elements selected from the group consisting of neodymium (Nd), praseodymium (Pr), and yttrium (Y) is more than 0.0030 wt %, the ratio of sulfide-based inclusions with a diameter of 10 nm to 100 nm to all sulfide-based inclusions may be more than 15% and thus the core loss of the manufactured non-oriented electrical steel sheet may increase and the magnetic flux density may decrease. This will be described below in more detail.

In the hot rolling operation S100, the slab may be reheated and then the reheated slab may be hot-rolled to produce a hot-rolled steel sheet. For example, a steel sheet having undergone the hot rolling operation S100 may be referred to as a hot-rolled steel sheet.

First, in the hot rolling operation S100, the slab may be reheated. The slab reheating temperature may be 1,100 °C to 1,250 °C. When the slab reheating temperature is lower than 1,100 °C, the rolling load during hot rolling (e.g., rough rolling and/or finish rolling) may increase and thus the rollability may degrade. On the other hand, when the slab reheating temperature is higher than 1,250 °C, a precipitate such as C, S, or N in the slab may be redissolved and thus a fine precipitate may be formed in the subsequent rolling and annealing operation, which may suppress the grain growth and degrade the magnetic property.

In the hot rolling operation S100, the slab may be hot-rolled at a certain final rolling temperature (or rolling temperature). In this case, the final rolling temperature may be 800 °C to 1,000 °C.

Also, in the hot rolling operation S100, the hot-rolled steel sheet may be cooled to a certain coiling temperature (CT) and then coiled. In this case, the coiling temperature may be 600 °C to 700 °C.

The thickness of the hot-rolled steel sheet produced through the hot rolling operation S100 may be 1.6 mm to 2.7 mm. In this case, when the thickness of the hot-rolled steel sheet is more than 2.7 mm, the cold rolling reduction rate may increase and thus the texture may degrade.

The cold rolling operation S200 may be performed after the hot rolling operation S100. In the cold rolling operation S400, the hot-rolled steel sheet may be cold-rolled to produce a cold-rolled steel sheet. For example, a steel sheet having undergone the cold rolling operation S200 may be referred to as a cold-rolled steel sheet.

Before the cold rolling operation S200, a pickling solution may be used to remove an oxide layer formed on the surface of the hot-rolled steel sheet.

In the cold rolling operation S200, the hot-rolled steel sheet may be cold-rolled to a thickness of 0.7 mm or less. For example, the thickness of the cold-rolled steel sheet produced through the cold rolling operation S200 may be 0.2 mm to 0.7 mm. In this case, in order to provide rollability, the plate temperature may be increased to 150 °C to 200 °C to perform warm rolling. However, the present disclosure is not limited thereto. Cold rolling may be performed at room temperature.

The reduction ratio in the cold rolling operation S200 may be 70% to 95%. For example, the reduction ratio in the cold rolling operation S200 may be 75% to 95%. For example, the reduction ratio in the cold rolling operation S200 may be 75% to 90%.

The cold annealing operation S300 may be performed after the cold rolling operation S200. In this case, the cold annealing operation S300 may be referred to as a final annealing operation. In the cold annealing operation S300, the cold-rolled steel sheet may be annealed.

In the cold annealing operation S300, the cold-rolled steel sheet may be heated to a cold annealing temperature (e.g., a maintenance temperature) at a temperature rise rate (or a heating rate) of 10 °C/s or more, then annealed at a cold annealing temperature for a time of 30 s to 90 s, and then cooled at a cooling rate of 30 °C/s or more. In this case, the cold annealing temperature (e.g., maintenance temperature) may be 900 °C to 1100 °C. When the cold annealing temperature is lower than 900 °C, the grain size may be fine and thus a hysteresis loss may increase. On the other hand, when the cold annealing temperature is higher than 1,100 °C, the grain size may become coarse and thus an eddy current loss may increase.

In an embodiment, the average grain size after annealing may be 50 μm to 100 μm.

In order to prevent surface oxidation and nitration, the cold annealing operation S300 may be performed under a mixed gas atmosphere. For example, a mixed gas atmosphere of nitrogen and hydrogen may be used to further smooth the surface state.

After the cold annealing operation S300, a coating layer may be formed on the cold-annealed cold-rolled steel sheet. By forming the coating layer, the punchability may be improved and the insulation may be ensured.

In an embodiment, a non-oriented electrical steel sheet may be manufactured through the hot rolling operation S100 to the cold annealing operation S300.

A non-oriented electrical steel sheet according to an embodiment of the present disclosure may include silicon (Si), manganese (Mn), aluminum (Al), sulfur (S), rare earth elements, remainder iron (Fe), and unavoidable impurities. In this case, the rare earth elements may include one or more elements selected from the group consisting of neodymium (Nd), praseodymium (Pr), and yttrium (Y).

Particularly, the non-oriented electrical steel sheet may include, in wt %, silicon (Si) of 1.0 wt % to 1.5 wt %, manganese (Mn) of 0.1 wt % to 0.4 wt %, aluminum (Al) of 0.1 wt % to 0.4 wt %, sulfur (S) of more than 0 wt % to 0.003 wt %, rare earth elements of more than 0.0006 wt % to 0.0030 wt %, remainder iron (Fe), and unavoidable impurities. In this case, the rare earth elements may include one or more elements selected from the group consisting of neodymium (Nd), praseodymium (Pr), and yttrium (Y). Thus, the non-oriented electrical steel sheet may include a sum of one or more elements of more than 0.0006 wt % to 0.0030 wt %, the one or more elements being selected from the group consisting of neodymium (Nd), praseodymium (Pr), and yttrium (Y). For example, the non-oriented electrical steel sheet may include a sum of one or more elements of 0.0007 wt % to 0.0030 wt %, the one or more elements being selected from the group consisting of neodymium (Nd), praseodymium (Pr), and yttrium (Y).

Also, the non-oriented electrical steel sheet may further include carbon (C) of more than 0 wt % to 0.003 wt %, phosphorus (P) of more than 0 wt % to 0.1 wt %, nitrogen (N) of more than 0 wt % to 0.003 wt %, and titanium (Ti) of more than 0 wt % to 0.003 wt %.

In an embodiment, the average grain size of the non-oriented electrical steel sheet may be 50 μm to 100 μm.

In an embodiment, the core loss of the non-oriented electrical steel sheet (e.g., based on W_{15/50}) may be 4.21 W/kg or less. Particularly, the core loss of the non-oriented electrical steel sheet (e.g., based on W_{15/50}) may be 3.7 W/kg to 4.21 W/kg. For example, the core loss of the non-oriented electrical steel sheet (e.g., based on W_{15/50}) may be 3.7 W/kg to less than 4.09 W/kg. For example, the core loss of the non-oriented electrical steel sheet (e.g., based on W_{15/50}) may be 3.7 W/kg to 4.05 W/kg.

In an embodiment, the magnetic flux density of the non-oriented electrical steel sheet (e.g., based on B₅₀) may be 1.695 T or more. Particularly, the magnetic flux density of the non-oriented electrical steel sheet (e.g., based on B₅₀) may be 1.695 T to 1.72 T.

Inclusions generated due to impurities may interfere with a magnetization process of a non-oriented electrical steel sheet, which may lead to an increased core loss and a decreased magnetic flux density. Particularly, the movement of a magnetic domain wall may be essential in the magnetization process; however, sulfide-based inclusions (e.g., MnS and TiS) formed by sulfur (S) included in the slab (or the non-oriented electrical steel sheet) may interfere with the movement of the magnetic domain wall, thus increasing the core loss and decreasing the magnetic flux density. In this case, among the sulfide-based inclusions, sulfide-based inclusions with a diameter of 10 nm to 100 nm, which is similar in size to the thickness of the magnetic domain wall, may most significantly interfere with the movement of the magnetic domain wall. Also, among the sulfide-based inclusions with a diameter of 10 nm to 100 nm, sulfide-based inclusions with a diameter of 10 nm to 50 nm may interfere with the movement of the magnetic field wall more than sulfide-based inclusions with a diameter of 50 nm to 100 nm.

Thus, when the amount (or number or ratio) of sulfide-based inclusions with a diameter of 10 nm to 100 nm among the sulfide-based inclusions is reduced, the core loss of the non-oriented electrical steel sheet may be reduced and the magnetic flux density may be increased. Also, when the amount (or number) of sulfide-based inclusions with a diameter of 10 nm to 50 nm among the sulfide-based inclusions with a diameter of 10 nm to 100 nm is reduced, the core loss of the non-oriented electrical steel sheet may be reduced and the magnetic flux density may be increased.

In an embodiment, when rare earth elements are added to the slab (or the non-oriented electrical steel sheet), the rare earth elements may react with sulfur to form sulfide-based inclusions, and the diameter of the sulfide-based inclusions formed when the rare earth elements are added may increase. For example, the amount (or number or ratio) of sulfide-based inclusions with a diameter of more than 100 nm may increase, and the amount (or number or ratio) of sulfide-based inclusions with a diameter of 10 nm to 100 nm may decrease. In this case, the rare earth elements may include neodymium (Nd), praseodymium (Pr), and/or yttrium (Y).

In a non-oriented electrical steel sheet and a method of manufacturing the same according to an embodiment of the present disclosure, rare earth elements may be added to the slab (or the non-oriented electrical steel sheet) to reduce the amount (or number or ratio) of sulfide-based inclusions with a diameter of 10 nm to 100 nm among the sulfide-based inclusions to improve the magnetic characteristics of the manufactured non-oriented electrical steel sheet.

Particularly, a sum of one or more elements of more than 0.0006 wt % to 0.0030 wt % (e.g., 0.0007 wt % to 0.0030 wt %), the one or more elements being selected from the group consisting of neodymium (Nd), praseodymium (Pr), and yttrium (Y) may be added to the slab (or the non-oriented electrical steel sheet) such that neodymium (Nd), praseodymium (Pr), and/or yttrium (Y) may react with sulfur (S) to form sulfide-based inclusions, thereby reducing the amount (or number or ratio) of sulfide-based inclusions with a diameter of 10 nm to 100 nm among the sulfide-based inclusions, thus reducing the core loss of the manufactured non-oriented electrical steel sheet and increasing the magnetic flux density.

As described above, the slab (or the non-oriented electrical steel sheet) may include a sum of one or more elements of more than 0.0006 wt % to 0.0030 wt % (e.g., 0.0007 wt % to 0.0030 wt %), the one or more elements being selected from the group consisting of neodymium (Nd), praseodymium (Pr), and yttrium (Y). When the sum of one or more elements selected from the group consisting of neodymium (Nd), praseodymium (Pr), and yttrium (Y) satisfies more than 0.0006 wt % to 0.0030 wt % (e.g., 0.0007 wt % to 0.0030 wt %), the amount (or number) of sulfide-based inclusions with a diameter of 10 nm to 100 nm among all sulfide-based inclusions may be reduced and thus the core loss of the manufactured non-oriented electrical steel sheet may decrease and the magnetic flux density may increase.

In an embodiment, the ratio of sulfide-based inclusions with a diameter of 10 nm to 100 nm to all sulfide-based inclusions may be 15% or less. For example, when the number of all sulfide-based inclusions is denoted as B and the number of sulfide-based inclusions with a diameter of 10 nm to 100 nm is denoted as A, the ratio of sulfide-based inclusions with a diameter of 10 nm to 100 nm to all sulfide-based inclusions may satisfy Relationship 1 below.

A/B*100≤15% <Relationship 1>

In this case, when the ratio of sulfide-based inclusions with a diameter of 10 nm to 100 nm to all sulfide-based inclusions is more than 15%, because the amount (or number) of sulfide-based inclusions with a diameter of 10 nm to 100 nm, which interfere with the movement of the magnetic domain wall, is too great, the movement of the magnetic domain wall may be disturbed and thus the core loss may be increased and the magnetic flux density may be reduced. For example, when the ratio of sulfide-based inclusions with a diameter of 10 nm to 100 nm to all sulfide-based inclusions is more than 15%, the non-oriented electrical steel sheet may have a high core loss and a low magnetic flux density.

In an embodiment, when the ratio of sulfide-based inclusions with a diameter of 10 nm to 50 nm to the sulfide-based inclusions with a diameter of 10 nm to 100 nm is denoted as S_{10~50} and the ratio of sulfide-based inclusions with a diameter of 50 nm to 100 nm among the sulfide-based inclusions with a diameter of 10 nm to 100 nm is denoted as S_{50~100}, then S_{10~50} and S_{50~100} may satisfy Relationship 2 below.

(S_{10~50})²/(S_{50~100})≤20 <Relationship 2>

In this case, when S_{10~50} and S_{50~100} do not satisfy Relationship 2, because the amount (or number) of sulfide-based inclusions with a diameter of 10 nm to 50 nm among the sulfide-based inclusions with a diameter of 10 nm to 100 nm is great, the movement of the magnetic domain wall may be disturbed and thus the core loss may increase and the magnetic flux density may decrease. For example, when S_{10~50} and S_{50~100} do not satisfy Relationship 2, the non-oriented electrical steel sheet may have a high core loss and a low magnetic flux density.

### Experimental Example

Hereinafter, the present disclosure will be described in more detail through the Experimental Example. However, the following Experimental Example is intended to further describe the present disclosure, and the scope of the present disclosure is not limited to the following Experimental Example. Those of ordinary skill in the art may suitably modify or change the following Experimental Example within the scope of the present disclosure.

TABLE 1

| | Components (wt %) | | | | | | |
|---|---|---|---|---|---|---|---|
| | | | | Rare-earth elements | | | |
| Category | Si | Mn | Al | Nd | Y | Pr | Sum |
| Embodiment 1 | 1.31 | 0.19 | 0.19 | 0.0006 | 0.0002 | 0.0002 | 0.0010 |
| Embodiment 2 | 1.31 | 0.20 | 0.22 | 0.0016 | 0.0001 | 0.0001 | 0.0018 |
| Embodiment 3 | 1.29 | 0.21 | 0.21 | 0.0002 | 0.0005 | 0.0001 | 0.0008 |
| Embodiment 4 | 1.29 | 0.21 | 0.19 | 0.0003 | 0.0012 | 0.0001 | 0.0016 |
| Embodiment 5 | 1.29 | 0.19 | 0.19 | 0.0002 | 0.0002 | 0.0010 | 0.0014 |
| Embodiment 6 | 1.29 | 0.21 | 0.22 | 0.0002 | 0.0002 | 0.0020 | 0.0024 |
| Embodiment 7 | 1.28 | 0.21 | 0.21 | 0.0007 | 0.0007 | 0.0002 | 0.0016 |
| Embodiment 8 | 1.28 | 0.21 | 0.21 | 0.0011 | 0.0009 | 0.0003 | 0.0023 |
| Embodiment 9 | 1.32 | 0.20 | 0.20 | 0.0001 | 0.0010 | 0.0008 | 0.0019 |
| Embodiment 10 | 1.29 | 0.19 | 0.22 | 0.0002 | 0.0012 | 0.0012 | 0.0026 |
| Embodiment 11 | 1.30 | 0.19 | 0.22 | 0.0009 | 0.0001 | 0.0010 | 0.0020 |
| Embodiment 12 | 1.31 | 0.20 | 0.21 | 0.0013 | 0.0002 | 0.0014 | 0.0029 |
| Embodiment 13 | 1.28 | 0.20 | 0.19 | 0.0008 | 0.0006 | 0.0009 | 0.0023 |
| Embodiment 14 | 1.03 | 0.22 | 0.20 | 0.0007 | 0.0005 | 0.0006 | 0.0018 |
| Embodiment 15 | 1.45 | 0.19 | 0.22 | 0.0007 | 0.0006 | 0.0006 | 0.0019 |

TABLE 2

| | Components (wt %) | | | | |
|---|---|---|---|---|---|
| Category | C | S | P | N | Ti |
| Embodiment 1 | 0.0017 | 0.0020 | 0.0064 | 0.0022 | 0.0019 |
| Embodiment 2 | 0.0016 | 0.0019 | 0.0095 | 0.0021 | 0.0023 |
| Embodiment 3 | 0.0021 | 0.0021 | 0.0098 | 0.0023 | 0.0024 |
| Embodiment 4 | 0.0022 | 0.0022 | 0.0088 | 0.0018 | 0.0017 |
| Embodiment 5 | 0.0019 | 0.0018 | 0.0077 | 0.0024 | 0.0017 |
| Embodiment 6 | 0.0015 | 0.0019 | 0.0094 | 0.0017 | 0.0015 |
| Embodiment 7 | 0.0021 | 0.0019 | 0.0070 | 0.0023 | 0.0021 |
| Embodiment 8 | 0.0024 | 0.0022 | 0.0084 | 0.0024 | 0.0020 |
| Embodiment 9 | 0.0015 | 0.0021 | 0.0077 | 0.0023 | 0.0018 |
| Embodiment 10 | 0.0019 | 0.0019 | 0.0063 | 0.0024 | 0.0021 |
| Embodiment 11 | 0.0025 | 0.0019 | 0.0095 | 0.0021 | 0.0018 |
| Embodiment 12 | 0.0016 | 0.0019 | 0.0056 | 0.0018 | 0.0024 |
| Embodiment 13 | 0.0022 | 0.0022 | 0.0097 | 0.0016 | 0.0024 |
| Embodiment 14 | 0.0023 | 0.0019 | 0.0093 | 0.0019 | 0.0018 |
| Embodiment 15 | 0.0024 | 0.0018 | 0.0088 | 0.0019 | 0.0021 |

TABLE 3

| | Components (wt %) | | | | | | |
|---|---|---|---|---|---|---|---|
| | | | | Rare-earth elements | | | |
| Category | Si | Mn | Al | Nd | Y | Pr | Sum |
| Comparative | 1.30 | 0.22 | 0.21 | 0.0002 | 0.0003 | 0.0001 | 0.0006 |
| Example 1 | | | | | | | |
| Comparative | 1.30 | 0.19 | 0.20 | 0.0030 | 0.0002 | 0.0002 | 0.0034 |
| Example 2 | | | | | | | |
| Comparative | 1.32 | 0.20 | 0.19 | 0.0002 | 0.0028 | 0.0002 | 0.0032 |
| Example 3 | | | | | | | |
| Comparative | 1.28 | 0.20 | 0.21 | 0.0003 | 0.0002 | 0.0027 | 0.0032 |
| Example 4 | | | | | | | |
| Comparative | 0.95 | 0.18 | 0.20 | 0.0007 | 0.0007 | 0.0005 | 0.0019 |
| Example 5 | | | | | | | |
| Comparative | 1.55 | 0.19 | 0.20 | 0.0008 | 0.0005 | 0.0007 | 0.0020 |
| Example 6 | | | | | | | |

TABLE 4

| | Components (wt %) | | | | |
|---|---|---|---|---|---|
| Category | C | S | P | N | Ti |
| Comparative | 0.0021 | 0.0021 | 0.0064 | 0.0018 | 0.0025 |
| Example 1 | | | | | |
| Comparative | 0.0021 | 0.0022 | 0.0065 | 0.0019 | 0.0022 |
| Example 2 | | | | | |
| Comparative | 0.0020 | 0.0020 | 0.0073 | 0.0020 | 0.0018 |
| Example 3 | | | | | |
| Comparative | 0.0021 | 0.0018 | 0.0088 | 0.0016 | 0.0024 |
| Example 4 | | | | | |
| Comparative | 0.0024 | 0.0022 | 0.0084 | 0.0018 | 0.0021 |
| Example 5 | | | | | |
| Comparative | 0.0020 | 0.0019 | 0.0067 | 0.0015 | 0.0019 |
| Example 6 | | | | | |

TABLE 5

| | | |
|---|---|---|
| Hot rolling | Slab reheating temperature (°C) | 1220 |
| operation | Final rolling temperature (°C) | 940 |
| | Coiling temperature (°C) | 680 |
| | Hot rolling thickness (mm) | 2.3 |
| Cold rolling | Reduction ratio (%) | 78.3 |
| operation | Cold rolling thickness (mm) | 0.5 |
| Cold annealing | Temperature rise rate (°C/s) | 40 |
| operation | Annealing temperature (°C) | 930 |
| | Duration time (s) | 60 |
| | Cooling rate (°C/s) | 40 |

TABLE 6

| | | | | | Magnetic | |
|---|---|---|---|---|---|---|
| | Ratio of sulfide-based inclusions | | | | characteristics | |
| | with particular diameter | | | | | Magnetic |
| | to all sulfide-based inclusions | | | Value of | Core loss | flux |
| | 10~50 nm | 50~100 nm | 10~100 nm | Relationship | (W_{15/50}, | density |
| Category | (%) | (%) | (%) | 2 | W/kg) | (B₅₀, T) |
| Embodiment 1 | 3.8 | 8.5 | 12.3 | 13.81 | 4.01 | 1.707 |
| Embodiment 2 | 3.3 | 6.3 | 9.6 | 18.01 | 4 | 1.708 |
| Embodiment 3 | 3.4 | 8.9 | 12.3 | 10.56 | 3.99 | 1.71 |
| Embodiment 4 | 2.1 | 6.6 | 8.7 | 7.68 | 3.95 | 1.711 |
| Embodiment 5 | 3.9 | 9 | 12.9 | 13.10 | 4 | 1.711 |
| Embodiment 6 | 2.3 | 7.8 | 10.1 | 6.71 | 3.96 | 1.713 |
| Embodiment 7 | 3.8 | 8.6 | 12.4 | 13.54 | 3.97 | 1.706 |
| Embodiment 8 | 3.5 | 8.1 | 11.6 | 13.04 | 3.94 | 1.712 |
| Embodiment 9 | 3.5 | 7.9 | 11.4 | 13.60 | 3.96 | 1.71 |
| Embodiment 10 | 3.4 | 7.8 | 11.2 | 13.23 | 3.93 | 1.713 |
| Embodiment 11 | 3.6 | 6.9 | 10.5 | 17.89 | 3.97 | 1.709 |
| Embodiment 12 | 3.9 | 9.3 | 13.2 | 12.39 | 4.01 | 1.706 |
| Embodiment 13 | 3.3 | 6.1 | 9.4 | 18.99 | 3.94 | 1.712 |
| Embodiment 14 | 3.5 | 8.8 | 12.3 | 11.23 | 4.21 | 1.719 |
| Embodiment 15 | 3.6 | 8.8 | 12.4 | 11.85 | 3.8 | 1.695 |

TABLE 7

| | | | | | Magnetic | |
|---|---|---|---|---|---|---|
| | Ratio of sulfide-based inclusions | | | | characteristics | |
| | with particular diameter | | | | | Magnetic |
| | to all sulfide-based inclusions | | | Value of | Core loss | flux |
| | 10~50 nm | 50~100 nm | 10~100 nm | Relationship | (W_{15/50}, | density |
| Category | (%) | (%) | (%) | 2 | W/kg) | (B₅₀, T) |
| Comparative | 10.1 | 11 | 21.1 | 43.95 | 4.15 | 1.693 |
| Example 1 | | | | | | |
| Comparative | 8.7 | 11.2 | 19.9 | 33.96 | 4.1 | 1.694 |
| Example 2 | | | | | | |
| Comparative | 7.1 | 11.7 | 18.8 | 22.92 | 4.09 | 1.694 |
| Example 3 | | | | | | |
| Comparative | 6.6 | 10.8 | 17.4 | 23.18 | 4.09 | 1.693 |
| Example 4 | | | | | | |
| Comparative | 6.6 | 11.0 | 17.6 | 22.50 | 4.41 | 1.72 |
| Example 5 | | | | | | |
| Comparative | 6.7 | 11.7 | 18.4 | 20.85 | 3.81 | 1.692 |
| Example 6 | | | | | | |

Embodiments 1 to 15 and Comparative Examples 1 to 6 may be samples of the slab including the components illustrated in Tables 1 to 4, remainder iron (Fe), and unavoidable impurities manufactured under the process conditions illustrated in Table 5. In this case, all the samples are manufactured to the same size of a width of 80 mm and a length of 150 mm.

Embodiments 1 to 15 and Comparative Examples 1 to 6 were manufactured under the same process condition, but under the condition of different component contents.

The number of sulfide-based inclusions was measured through an SEM-EDS analysis. Particularly, an observation specimen (15×15 mm in size) was taken from the manufactured sample, and mirror-polishing of 1 μm or less was performed on the specimen surface (ND side) and the specimen center (thickness center point), and then, an analysis was performed at the thickness-direction center point of the specimen under conditions of an analysis area of 160 mm² or more, a magnification of ×100, and a dwell time of 0.1 seconds. Also, after measuring more than 2,000 fields based on a spherical diameter of 0.4 μm in units of detecting pixels, the average number of inclusions per area of 100 mm² was calculated.

The value of Relationship 2 may correspond to (S_{10~50})²/(S_{50~100}), S_{10~50} may correspond to the ratio of sulfide-based inclusions with a diameter of 10 nm to 50 nm to the sulfide-based inclusions with a diameter of 10 nm to 100 nm, and S_{50~100} may correspond to the ratio of sulfide-based inclusions with a diameter of 50 nm to 100 nm to the sulfide-based inclusions with a diameter of 10 nm to 100 nm.

The magnetic characteristics were measured twice each in the rolling direction and the rolling perpendicular direction by using a single sheet tester (SST) and calculated as an average value. In this case, W_{15/50} represents the core loss when a magnetic flux density of 1.5 Tesla is induced at a frequency of 50 Hz, and B₅₀ represents the magnetic flux density induced when a magnetic field of 5000 A/m is applied.

Referring to Tables 6 to 7, in the case of Embodiments 1 to 15, it may be seen that the ratio of sulfide-based inclusions with a diameter of 10 nm to 100 nm to all sulfide-based inclusions is 15% or less. Also, in the case of Embodiments 1 to 15, it may be seen that the value of Relationship 2 is 20 or less. Thus, it may be seen that Embodiments 1 to 15 have a low core loss and a high magnetic flux density.

On the other hand, Comparative Example 1 is a case where the content of rare earth elements in the slab (or the non-oriented electrical steel sheet) is 0.0006 wt % or less, and in the case of Comparative Example 1, it may be seen that the ratio of sulfide-based inclusions with a diameter of 10 nm to 100 nm to all sulfide-based inclusions is more than 15% and the value of Relationship 2 is greater than 20. Also, it may be seen that Comparative Example 1 has a higher core loss and/or a lower magnetic flux density compared to the Embodiments.

Comparative Example 2 is a case where the content of rare earth elements in the slab (or the non-oriented electrical steel sheet) is more than 0.0030 wt %, and in the case of Comparative Example 2, it may be seen that the ratio of sulfide-based inclusions with a diameter of 10 nm to 100 nm to all sulfide-based inclusions is more than 15% and the value of Relationship 2 is greater than 20. Also, it may be seen that Comparative Example 2 has a higher core loss and/or a lower magnetic flux density compared to the Embodiments.

Comparative Example 3 is a case where the content of rare earth elements in the slab (or the non-oriented electrical steel sheet) is more than 0.0030 wt %, and in the case of Comparative Example 3, it may be seen that the ratio of sulfide-based inclusions with a diameter of 10 nm to 100 nm to all sulfide-based inclusions is more than 15% and the value of Relationship 2 is greater than 20. Also, it may be seen that Comparative Example 3 has a higher core loss and/or a lower magnetic flux density compared to the Embodiments.

Comparative Example 4 is a case where the content of rare earth elements in the slab (or the non-oriented electrical steel sheet) is more than 0.0030 wt %, and in the case of Comparative Example 4, it may be seen that the ratio of sulfide-based inclusions with a diameter of 10 nm to 100 nm to all sulfide-based inclusions is more than 15% and the value of Relationship 2 is greater than 20. Also, it may be seen that Comparative Example 4 has a higher core loss and/or a lower magnetic flux density compared to the Embodiments.

Through Comparative Examples 2 to 4, it may be seen that the effect of reducing sulfide-based inclusions with a diameter of 10 nm to 100 nm is negligible when the content of rare earth elements in the slab (or the non-oriented electrical steel sheet) is more than 0.0030 wt %. Also, when the amount of added rare earth elements is more than 0.0030 wt %, the manufacturing cost may increase and thus the economic efficiency of the manufacturing process may decrease.

Comparative Example 5 is a case where the content of silicon (Si) in the slab (or the non-oriented electrical steel sheet) is less than 1.0 wt %, and in the case of Comparative Example 5, it may be seen that the ratio of sulfide-based inclusions with a diameter of 10 nm to 100 nm to all sulfide-based inclusions is more than 15% and the value of Relationship 2 is greater than 20. Also, it may be seen that Comparative Example 5 has a higher core loss than the Embodiments. Thus, when the content of silicon (Si) in the slab (or the non-oriented electrical steel sheet) is less than 1.0 wt %, even when a sum of rare earth elements of more than 0.0006 wt % to 0.0030 wt % are added, the effect of adding rare earth elements may be negligible and thus the manufactured non-oriented electrical steel sheet may have a high core loss.

Comparative Example 6 is a case where the content of silicon (Si) in the slab (or the non-oriented electrical steel sheet) is more than 1.5 wt %, and in the case of Comparative Example 6, it may be seen that the ratio of sulfide-based inclusions with a diameter of 10 nm to 100 nm to all sulfide-based inclusions is more than 15% and the value of Relationship 2 is greater than 20. Also, it may be seen that Comparative Example 6 has a lower magnetic flux density than the Embodiments. Thus, when the content of silicon (Si) in the slab (or the non-oriented electrical steel sheet) is more than 1.5 wt %, even when a sum of rare earth elements of more than 0.0006 wt % to 0.0030 wt % are added, the effect of adding rare earth elements may be negligible and thus the manufactured non-oriented electrical steel sheet may have a low magnetic flux density.

Although the present disclosure has been described with reference to the embodiments illustrated in the drawings, this is merely an example and those of ordinary skill in the art will understand that various modifications and other equivalent embodiments may be derived therefrom. Thus, the spirit and scope of the present disclosure should be defined by the appended claims.

1. A method of manufacturing a non-oriented electrical steel sheet, the method comprising:
hot-rolling a slab comprising, in wt %, silicon (Si) of 1.0 wt % to 1.5 wt %, manganese (Mn) of 0.1 wt % to 0.4 wt %, aluminum (Al) of 0.1 wt % to 0.4 wt %, sulfur (S) of more than 0 wt % to 0.003 wt %, a sum of one or more elements of more than 0.0006 wt % to 0.0030 wt %, the one or more elements being selected from the group consisting of neodymium (Nd), praseodymium (Pr), and yttrium (Y), remainder iron (Fe), and unavoidable impurities to provide hot-rolled steel sheet;
cold-rolling the hot-rolled steel sheet to provide a cold-rolled steel sheet; and
cold-annealing the cold-rolled steel sheet.

2. The method of claim 1 wherein a non-oriented electrical steel sheet is provided.

3. The method of claim 1, wherein a ratio of sulfide-based inclusions with a diameter of 10 nm to 100 nm to all sulfide-based inclusions satisfies Relationship 1 below:
A/B*100≤15%, <Relationship 1>
where A is a number of sulfide-based inclusions with a diameter of 10 nm to 100 nm, and B is a number of all sulfide-based inclusions.

4. The method of claim 1, wherein a ratio of sulfide-based inclusions with a diameter of 10 nm to 50 nm to sulfide-based inclusions with a diameter of 10 nm to 100 nm and a ratio of sulfide-based inclusions with a diameter of 50 nm to 100 nm to the sulfide-based inclusions with a diameter of 10 nm to 100 nm satisfy Relationship 2 below:
(S_{10~50})²/(S_{50~100})≤20, <Relationship 2>
where S_{10~50} corresponds to the ratio of the sulfide-based inclusions with a diameter of 10 nm to 50 nm to the sulfide-based inclusions with a diameter of 10 nm to 100 nm, and S_{50~100} corresponds to the ratio of the sulfide-based inclusions with a diameter of 50 nm to 100 nm to the sulfide-based inclusions with a diameter of 10 nm to 100 nm.

5. The method of claim 2, wherein the non-oriented electrical steel sheet has a magnetic flux density of 1.695 T or more (based on B₅₀).

6. The method of claim 2, wherein an average grain size of the non-oriented electrical steel sheet is 50 μm to 100 μm.

7. The method of claim 2, wherein, in the hot rolling, the slab is reheated to 1100 °C to 1250 °C, and the reheated slab is hot-rolled at a final rolling temperature of 800 °C to 1000 °C.

8. The method of claim 1, wherein, in the cold annealing, the cold-rolled steel sheet is heated to a temperature of 900 °C to 1100 °C at a heating rate of 10 °C/s or more, maintained at a temperature of 900 °C to 1100 °C for a time of 30 s to 90 s, and then cooled at a cooling rate of 30 °C/s or more.

9. The method of claim 1, wherein the slab comprises a sum of one or more elements of 0.0007 wt % to 0.0030 wt %, the one or more elements being selected from the group consisting of neodymium (Nd), praseodymium (Pr), and yttrium (Y).

10. The method of claim 1, wherein the slab further comprises carbon (C) of more than 0 wt % to 0.003 wt %, phosphorus (P) of more than 0 wt % to 0.1 wt %, nitrogen (N) of more than 0 wt % to 0.003 wt %, and titanium (Ti) of more than 0 wt % to 0.003 wt %.

11. A non-oriented electrical steel sheet comprising,
in wt %, silicon (Si) of 1.0 wt % to 1.5 wt %, manganese (Mn) of 0.1 wt % to 0.4 wt %, aluminum (Al) of 0.1 wt % to 0.4 wt %, sulfur (S) of more than 0 wt % to 0.003 wt %, a sum of one or more elements of more than 0.0006 wt % to 0.0030 wt %, the one or more elements being selected from the group consisting of neodymium (Nd), praseodymium (Pr), and yttrium (Y), remainder iron (Fe), and unavoidable impurities.

12. The non-oriented electrical steel sheet of claim 11, wherein a ratio of sulfide-based inclusions with a diameter of 10 nm to 100 nm to all sulfide-based inclusions satisfies Relationship 3 below:
A/B*100≤15%, <Relationship 3>
where A is a number of sulfide-based inclusions with a diameter of 10 nm to 100 nm, and B is a number of all sulfide-based inclusions.

13. The non-oriented electrical steel sheet of claim 11, wherein a ratio of sulfide-based inclusions with a diameter of 10 nm to 50 nm to sulfide-based inclusions with a diameter of 10 nm to 100 nm and a ratio of sulfide-based inclusions with a diameter of 50 nm to 100 nm to the sulfide-based inclusions with a diameter of 10 nm to 100 nm satisfy Relationship 4 below:
(S_{10~50})²/(S_{50~100})≤20, <Relationship 4>
where S_{10~50} corresponds to the ratio of the sulfide-based inclusions with a diameter of 10 nm to 50 nm to the sulfide-based inclusions with a diameter of 10 nm to 100 nm, and S_{50~100} corresponds to the ratio of the sulfide-based inclusions with a diameter of 50 nm to 100 nm to the sulfide-based inclusions with a diameter of 10 nm to 100 nm.

14. The non-oriented electrical steel sheet of claim 11, wherein the non-oriented electrical steel sheet has a magnetic flux density of 1.695 T or more (based on B₅₀).

15. The non-oriented electrical steel sheet of claim 11, wherein an average grain size of the non-oriented electrical steel sheet is 50 μm to 100 μm.

16. The non-oriented electrical steel sheet of claim 11, wherein the slab comprises a sum of one or more elements of 0.0007 wt % to 0.0030 wt %, the one or more elements being selected from the group consisting of neodymium (Nd), praseodymium (Pr), and yttrium (Y).
